(19) United States
(12) Patent Application Publication
(10) Pub. No.: US 2011/0217683 A1
(43) Pub. Date: Sep. 8, 2011

(54) METHODS AND SYSTEMS FOR USING A VISUAL SIGNAL AS A CONCENTRATION AID

(76) Inventors: Olga Vlasenko, Brooklyn, NY (US); Elizaveta Smolovik, Brooklyn, NY (US)

(21) Appl. No.: 12/833,583

(22) Filed: Jul. 9, 2010

Related U.S. Application Data
(60) Provisional application No. 61/310,660, filed on Mar. 4, 2010.

(51) Int. Cl. G09B 19/00

(52) U.S. Cl. 434/257

(57) ABSTRACT

The present application provides a system and method of utilizing a visual signal of light as concentration aid to increase the effectiveness of physical exercises performed on, or applied to, a targeted body area. Visual images are displayed to the exerciser in such manner as to focus the exerciser's attention to the muscle group that is being targeted with the exercise. Each of the displayed images illustrates a human form showing at least the isolated muscle group and a visual cue in or about the isolated muscle group in varying degrees of intensity through the full range of movement of the exercise. The visual signal of light reinforces the sensory feeling in particular body area. The exerciser's brain generates the muscle reflex while the exerciser concentrates his or her attention on the visual signal of light that illuminates the targeted area of the human body through the entire exercise routine that is depicted in the interface screen.

### RELATED APPLICATION

This application claims the benefit of U.S. Provisional Application No. 61/310,660 filed on Mar. 4, 2010 which is incorporated into this application in its entirety by this reference.

### FIELD OF INVENTION

This application relates generally to methods and systems for improving concentration and more particularly methods and systems that provide a visual signal as an aid of concentration and an enhancement of body motor reflexes for a wide variety of physical fields.

### BACKGROUND

It has long been held that a regimen of regular exercise improves the quality of life at any age and at any level of fitness. Studies have also shown that properly designed exercise routines help to develop, rehabilitate and strengthen not only the muscles, but connective tissues and the skeletal system as well. Physical exercises help to reduce the amount of body fat and cholesterol; restores and improves the efficiency of the cardiovascular system; lowers blood pressure and thereby reduces the risk of heart attack and stroke. In addition, it is well known that physical exercise reduces mental stress and improves mental acuity.

As a result, individuals widely use physical exercises in everyday lives to maintain a good physical level of fitness by joining health clubs, purchasing specialized home fitness equipment, engaging in jogging, walking or bicycling, undertaking recreational activities that provide exercise benefits, and the like.

In medical field, physical exercises are used for the purposes of rehabilitation and restoration of muscular and joint movement, improvement of muscular control and flexibility.

Law enforcement agencies and armed forces utilize specially adopted physical exercise routines for speedy body recovery after physical activities and to increase of strength and endurance of muscles and muscle strains.

Unfortunately, there are several reasons why physical exercises do not result in any meaningful improvements in desired level of fitness. One of the main reasons that physical exercises do not produce desired results is lack of necessary level of concentration by the exercisers during the performance of exercise routines. Lack of concentration may result, among other reasons, due to incorrectly created exercise routines and lack of supervision over the exercise routines by trained professionals, therefore leads to improper workout, lack of desired result and traumas.

For example, while people prefer to exercise at home rather than at a health club, the people most in need of an exercise are also the people most likely to feel uncomfortable at a health club. Unfortunately, the home exerciser is usually not inclined to discuss his or her fitness objectives with a professional trainer, doctor, or physical therapist and is, therefore, likely to spend money on exercise equipment which is ineffective for producing the results desired by the individual. The exercise routines and exercise equipment may also be ineffective if it doesn't ensure the appropriate level of concentration by the exerciser for the entire duration of the physical exercise.

There is, therefore, a need for a system and method for directing a potential exerciser as to the proper exercises while maintaining necessary level of concentration by the exerciser to conduct exercises properly in order to achieve a desired result. The desired system and method may provide for input of the exercisers' data and desired goals; means for measuring the results of the exercise routines; means for conducting exercise routines at progressively higher intensities as needed; means for maintaining necessary level of concentration by the exerciser to conduct exercises properly; be suitable to a home or traveling users; and/or not requiring an undue investment in specialized equipment.

### SUMMARY OF THE INVENTION

The present invention is directed to systems and methods for the application of a visual signal of light or other stimuli as an aid of concentration and for enhancing or triggering physical reflexes.

Several experimental studies suggested the capability of a human brain to enhance or inhibit human reflexes by translating visual images processed by the human brain into motor or chemical functions within human bodies: muscle tissue, ligaments, blood vessels and organs. Studies stipulate that when a person looks at the image, the person's brain, stimulated by the image, activates the visual cortex. For example, if the image involves a sense of physical movement, a person's nerves and muscles produce perceptible movements that can be detected with an instrument called an electromyography (EMG). In another example, in response to viewing sad images, human brain is capable of initiating the creation of chemicals of depression. In another example, aggressive images trigger generation of adrenaline. In yet another example, images of sour food trigger generation of saliva. Further, if the image is relaxing, human body produces a natural tranquilizer that has a chemical structure similar to Valium. In another example, if a person has a certain phobia and he or she thinks about this very phobia, person's heart rate increases, acids are released into your digestive system, person's chest constricts and the throat tightens.

While mere processing of a visual imagery by a human brain causes physical or chemical reflexes in human body, enhancing the viewable image with a visual signal of light that illuminates the viewable image in whole or in part substantially increases the effectiveness of triggered reflexes. To better understand the benefit and a main purpose of a visual signal of light as an aid for concentration when it highlights the targeted area of the human body, one could use the analogy with a laser-guided missile system, where human eyes maintain visual contact with the targeted body area to better assist the human brain in precisely directing appropriate “command-missile” like attention to enhance and stimulate a physical or even chemical reflex within the targeted area.

In the preferred embodiments, the visual signal of light may be presented in the form of a highlighted focal point of attention. For example, the visual signal of light may be a fore- or a background of a targeted area of the human body, wherein the visual signal of light differs in color and presentation from the color and presentation of the targeted area itself. In another example, the visual signal of light may be the targeted area of the human body itself (the contracting muscles or muscle group) that is illuminated in color that is different from the color of other, not targeted, areas of human body that is depicted in the viewable image. When, during the exercise routines, attention of a person is directed at and maintained by the visual signal of light, the person's brain magnifies and accelerates the stimulation of a reflex in the targeted area. The reflex causes the targeted area to respond to commands of the brain in a more efficient way, producing a desirable result.

Methods and systems are generally provided for the display of visual images of physical exercise routines that are enhanced with a visual signal of light as a concentration aid wherein the exercise movements and the visual signal of light are shown on a wide variety of visual displays or screens, preferably presented in a manner such that an exerciser may better perform an exercise thereby increasing the effectiveness of the exercise routine.

The term “exercise routine” or “physical exercise” generally refers to at least one exercise, which itself is a series of movements, performed repeatedly and directed at least at one targeted area of body. The interface screen presented to the exerciser may display a selectable list of customizable (in rate, duration, positioning, etc.) exercises or routines that the exerciser may choose based on the exerciser's ability, desires, current level of fitness, pre-existing medical conditions, etc., and wherein each selectable exercise is directed at a targeted area of the body that is illuminated with the visual signal of light as aid of concentration throughout the exercise routine. It is to be understood that each movement is practiced in a cyclic manner. It should also be understood that not every cycle element may practically be completed in the exactly the same amount of time and thus to proceed at the same pace.

An exercise routine produced in one embodiment of the inventive method provides a plurality of exercise routines where each exercise routine provides a different movement for the selected muscle groups and the visual signal of light that illuminates a specific body area for the entire duration of a particular movement, while maintaining a non-targeted body area clear of the visual signal of light, when displayed on a monitor.

The visual signal of light is also provided so that the exerciser maintains the concentration and the pace of the exercise routine to achieve the desired result. The exerciser chooses an exercise routine from the list presented by the system on the screen and preferably follows that exercise routine and preferably maintains a focal point of the visual signal of light that illuminated the targeted body area for the duration of the exercise routine.

The duration of the exercise routine is controlled by a timer that is also displayed on the screen. Upon expiration of the timer, the exerciser preferably chooses a new exercise routine depending on a group of muscles selected from the list displayed on the screen and repeats the process for the duration suggested by the timer based on the initial parameters that were provided to the system by the exerciser.

The system and method disclosed in the current application offers the exerciser a choice to either maintain a complete control over his of her workout or to follow the exercise routine while maintaining the appropriate level of mental concentration supported by the visual signal of flashing light. The system and method disclosed in the current application also offers an option to pre-define the exercise routine based on several input parameters that comprise targeted muscle group, exercise intensity, physical and physiological data of the exerciser and other relevant factors (such as fitness training, medical rehabilitation, relaxation, stretching, yoga, etc.) that may be entered into a system by the exerciser.

While previous systems and methods of exercise routines are known to offer various simultaneous and consequent views of the body movement during the performance of the physical exercises, the inventive method provides views of a plurality of exercise training routines comprising displaying at least one image of an isolated muscle or a muscle group where the isolated muscle or the muscle group, at least in part, is illuminated by the visual signal of flashing light as aid of concentration.

The light may flash with various frequencies and color intensity to help the exerciser to maintain visual contact with the targeted body area that is displayed on the screen during the exercise. For example, in the beginning of the exercise routine the color intensity of the visual signal of light may differ from the color intensity of the light at the end of the exercise routine. Also, the frequency of flashes may differ throughout the duration of the exercise routine in order to accelerate the brain function to stimulate the reflex in the targeted area. In another example, in the beginning of the exercise the visual signal of light that illuminates the targeted body area may be displayed with in an initial (low or high) light intensity and at the end of the exercise with the visual signal of light that illuminates the targeted body area may be displayed in a second intensity different than the first intensity.

Fluctuation of the light intensity of the visual signal of light may depend from the type of the exercise routine that was chosen by the exerciser. For example, if the choice of the exercise is—yoga, the light intensity may be constant and light will be low and not flashing. In another example, if the choice of the exercise routine is—abs tune-up for the advanced exerciser, the rates of light intensity fluctuation and the flashing rate may be significantly higher than the rates of light intensity fluctuation and the flashing rate for the exercise routine of abs tune-up for the intermediate exerciser. In yet another example, if the choice of the exercise routine is—relaxation, the rates of light intensity fluctuation and the flashing rate may be low.

Depending on the type of the exercise routine, the system may be configured to set the light intensity and a flashing rate to be different at the different stages of the exercise routine. For example, the light intensity and a flashing rate may be low in the beginning of the exercise routine; then it can be high in the peak of the exercise routine; and it can low again at the end of the exercise routine. In yet another example, the light intensity and a flashing rate may be low in the beginning of the exercise routine and then it can be high in the peak and at the end of the of the exercise routine.

The visual signal of light also helps the exerciser set the optimal pace and amplitude of conducting the repetitive movements suggested by the exercise routine displayed on the screen to guide the exerciser to the optimal performance of the exercise routine. Most importantly, the visual signal of flashing light, that illuminates the targeted area of a body (a muscle or a particular muscle group currently worked on) enhances the exerciser's concentration of attention on the targeted body area and increases the effectiveness of the exercise routine performed for, or applied to, that body area by means of visual influence through the brain and further through neural connections to the muscle.

One of the apparent advantages of utilizing the visual signal of flashing light is maintaining the exerciser's level of concentration to the exercise routine so that the exerciser is not distracted by unrelated activities (such as reading or watching TV while using treadmills, rowing machines, step master machines, etc.). The exerciser closely monitors and follows the pace and the amplitude of the exercise routine that is set by the pace of light flashes and density of light patterns that are positioned in or about the targeted area of the human body (the targeted contracting muscle that is illuminated by the visual signal of light).

In the preferred embodiment of the current application, the main advantage of utilizing the visual signal of flashing light to highlight the targeted body area, muscle or muscle group, displayed on the monitor is to stimulate the exerciser's brain activity function to process visual signals of what is depicted on the monitor, through numerous stages of integration, involving the thalamus, cerebral cortex, basal ganglia, superior colliculus, cerebellum, and several brainstem nuclei, to initiate and stimulate the signal-processing function to transform the visual signal into a “motor planning” function wherein the “motor-planning” term means the muscular function to maintain an optimal performance of the targeted body area.

By the same token as aid in concentration during physical exercise routines whereby helping obtain quicker results, visual signal of light can aid in many fields of application, including medical field. One of the many examples includes a healing process, by the same method of concentration on a problem area and speeding up a recovery. Same way it can be applied in rehabilitation process, muscle movement restoration and flexibility improvement. In yet another example the present invention can also aid in relaxation process, by same means of helping concentrate on a particular muscle or muscle group and aid in relaxation of that area. Those skilled in the art should understand that the present invention is not limited to the methods of application in the medical field as described in the examples above.

A better understanding of the present invention, its several aspects, and its objects and advantages will become apparent to those skilled in the art from the following detailed description, taken in conjunction with the attached drawings, wherein there is shown and described the preferred embodiment of the invention, simply by way of illustration of the best mode contemplated for carrying out the invention.

Additional aspects of the present invention will be apparent in view of the description which follows.

### BRIEF DESCRIPTION OF THE FIGURES

FIG. 1 is a network diagram for a system according to at least one embodiment of the systems disclosed herein.

FIG. 2 is a diagram that illustrates the manner of influence of visual images, through the brain function, by means of neural connections, on local muscle.

FIG. 3 illustrates a depiction of a plurality of viewable areas on the screen view at the beginning of the exercise routine shown by a system according to at least on embodiment of the systems disclosed herein.

FIG. 4 illustrates a depiction of a plurality of viewable areas on the screen view reflecting the exercise routine in progress where each viewable area of the screen depicts a complete human body figure in dynamic or moving position of an exercise that targets a specific body area that is highlighted by the visual signal of a light shown by a system according to at least one embodiment of the systems disclosed herein.

FIG. 5 illustrates a singular viewable area of the screen displaying a full body figure at the beginning of the exercise routine shown by a system according to at least one embodiment of the systems disclosed herein.

FIG. 6 illustrates a singular viewable area of the screen displaying the exercise routine in progress where the screen depicts a complete human body figure in dynamic or moving position of an exercise that targets at least one specific body area that is highlighted by the visual signal of a light shown by a system according to at least on embodiment of the systems disclosed herein.

### DETAILED DESCRIPTION OF THE INVENTION

### Detailed Description of the System

Before explaining the methods and systems of the present application in detail, it is important to understand that the methods and systems disclosed herein are not limited in their application to the details illustrated and the steps described herein. The methods and systems disclosed herein are capable of other embodiments and of being practiced or carried out in a variety of ways. It is to be understood that the phraseology and terminology employed herein is for the purpose of description and not of limitation. While the following discussion is directed toward instruction for performing physical routines, the methods and systems disclosed herein are not limited to this particular application.

As described with reference to the accompanying Figures, the present application provides a system and method of utilizing a visual signal of light or other stimuli visual or otherwise as a concentration aid to increase the effectiveness of physical exercises performed on, or applied to, a targeted body area. That is, visual images are displayed to the exerciser in such manner as to focus the exerciser's attention to the muscle group that is being targeted with the exercise.

Specifically, each of the displayed images illustrates a human form showing at least the isolated muscle group and a visual cue in or about the isolated muscle group in varying degrees of intensity through the full range of movement of the exercise. As explained below, the visual signal of light reinforces the sensory feeling in particular body area. The main idea is that the exerciser's brain generates the muscle reflex while the exerciser concentrates his or her attention on the visual signal of light that illuminates the targeted area of the human body through the entire exercise routine that is depicted in the interface screen. Generally, as used herein, a muscle group is a muscle or set of muscles which act in concert to produce a particular movement. Common examples of muscle groups comprise the abdominals, pectorals (chest), deltoids (shoulders), trapezius (upper back), latisimus dorsi (back), biceps, triceps, gluteus, quadriceps, hamstrings, calves and neck.

Hardware and Software Overview

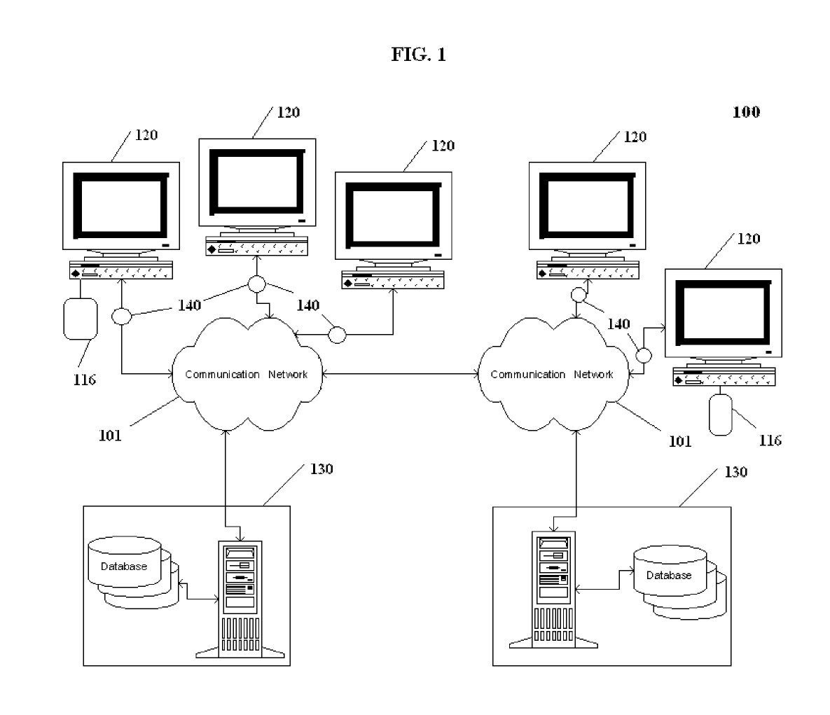

FIG. 1 is a block diagram that illustrates the system and method that employs an enhanced visual imaging as a concentration aid in accordance according to at least one embodiment. In one embodiment, the system 100 comprises at least one server 130, one or more communication networks 101, and plurality of client devices 120. It is understood that the client device 120 may be any device capable of displaying the visual images discussed herein, such as a personal computer, DVD player, set top cable box, etc. It is further understood that the client device 120 may be a standalone device, in the case of a DVD player, or a networked device. Intermediate devices such as gateways 140 and other such types of client devices may be used to establish and maintain connection between communication networks 101 and a connection between client devices and servers 130 so that client devices 120 can access and exchange the exercise routine information. It should be understood that the present invention is not limited to any particular system configuration. There are many other system configurations on which the preferred embodiments may be implemented.

The client device 120 may be an exercise apparatus terminal having exercise functionality in addition to being able to display the visual images disclosed herein. Such exercise apparatus terminals include by way of example, but not by way of limitation, stationary bicycles, stair climbers, steppers, rowing machines, ski machines, treadmills, cross trainers, and weight machines. These client devices 120 may be arranged at locations where exercise is performed without the use of an exercise apparatus, e.g., free weights, stretching, pull-ups, push-ups, sit-ups, etc. Exerciser data input terminals 116 for supplying exerciser data to the server 130 may also be incorporated into client devices 120. For example, weight, height, body fat index, blood pressure, heart rate, pre-existing medical conditions, targeted body areas and the like may also be entered into the server 130 so that such data can be used in the selection of exercise data for an exerciser. While FIG. 1 shows one embodiment of the exercise apparatus terminal having a plurality of exercise station terminals connected, through at least one communication network, to central computer 130, it will be appreciated that one or more of any or all of these terminals maybe connected in the network 100.

Exercise terminal network 100 is not limited to implementation in health club settings. The exercise apparatus terminals, exercise station terminals, and exerciser data input terminals described above can be provided at the same or at different locations. For example, a single central computer may be linked to input terminals 116 or client devices 120 in one or more health clubs, exercisers' homes, hotels, resorts, medical facilities, etc.

The exercisers may remotely access the server 130 using personal wired or wireless communication devices, i.e. computers, cellular phones, PDAs, etc., in order to access the exercise database and evaluate the exercisers' progress, as well as to upload a new exercise data. Where such remote access to the exercise database is provided, access to the data may be limited. For example, an exerciser might only be given “read” access to the database, while exercise consultants may be given “read/write” access to the database. In some instances, the read/write access of the exercise consultant might be limited to data regarding only those exercisers with whom the consultant is consulting. An exerciser whose weight and other physiological data is communicated to the server over communications networks 101, 110 may be given “write” access to the fields of the exercise database related to this information. Implementing a database having different access levels using passwords, for example, is well known and will not be described herein.

Client Devices

The client devices 120 are devices that provide an interface for exercisers to conduct the exercises. Some examples of client devices include a personal computer, laptop computer, handheld computer, set top box, and so forth. The client devices 120 according to one embodiment, include at least a processor and memory (not shown). Preferably, the processor has enough processing power to handle and process various types of exercise routine information. It should be understood that more exercise information is received and processed the more processing power is preferred. Memory may include a computer readable medium. The term computer readable medium, as used herein, refers to any medium that participates in providing instructions to processor for execution and/or store any of the forms of data discussed herein. Such a medium may take many forms, including but not limited to, non-volatile media, and transmission media. Non-volatile media includes, for example, optical or magnetic disks, such as a storage device. Volatile media include dynamic memory, such as main memory or random access memory (“RAM”). Common forms of computer-readable media include, for example, a floppy disk, a flexible disk, a hard disk, a magnetic tape, or any other magnetic medium, a CD-ROM, any optical medium, punch cards, paper tape, any other physical medium with patterns of holes, a RAM, a PROM, and EPROM, a FLASH-EPROM, and any other memory chip or cartridge, or any other medium from which a computer can read.

Monitors

According to at least one embodiment, the exercise information is transmitted by the server to the client devices 120 via communication network 101 and displayed on the visual output device or display device of the client devices 120. The output device can be any type of display. For example, the display could be a CRT-based video display, an LCD-based or a gas plasma-based flat-panel display, a display that shows three-dimensional images, or some other display type. The present invention is not limited to any particular type of display.

Gateways

Gateways 140 are devices such as a mainframe, superminicomputer, minicomputer workstation, microcomputer that establishes a connection between networks 101 and between client devices and servers 130 so that exercise routine information can be successfully communicated between client devices 120 and one or more servers 130. Gateways 140 preferably receive exercise routine information from the at least one server and convert it to a format compatible with the protocols used by the client devices 120 using conversion techniques known in the art. A user at one of the client devices 120 can subscribe to a wide variety of exercise-related information for a particular exercise routine hosted at the servers 130. The gateways 140 also preferably receive transaction information, such as physiological data, from the client devices 120 and forward that information to corresponding servers 130.

Servers

Servers 130 allow exercisers to access and subscribe to one or more exercise routines or programs. According to the preferred embodiments, servers 130 may comprise at least one processor and at least one database, wherein the at least one processor is communicatively connected to the at least one database. Servers 130 can store and execute numerous types of execution algorithms, and sometimes the type of algorithm depends on the type of the exercise routine being requested or designed by the exerciser. The preferred embodiments may be adapted by one skilled in the art of work with any particular execution algorithm. The present invention is not limited to any particular type of order execution algorithm.

Influence of Visual Images on Human Brain in Physical Exercising

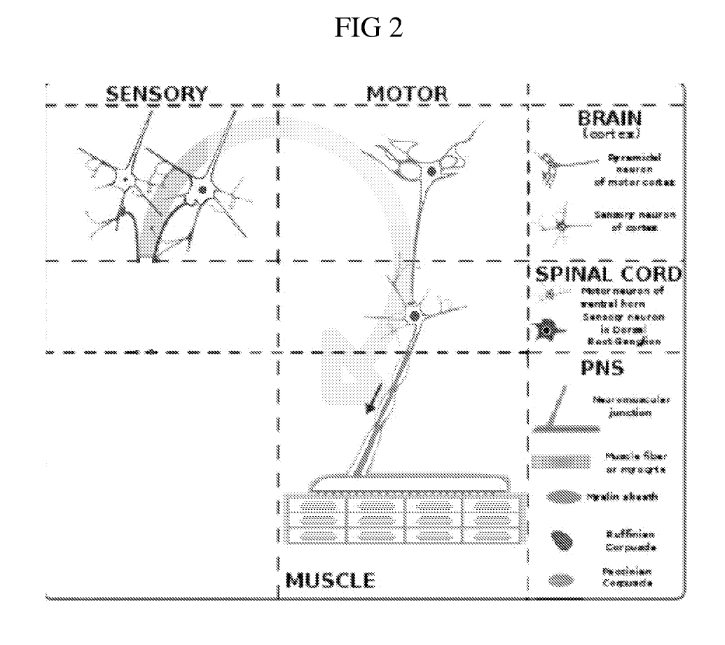

FIG. 2 illustrates the manner of influence of visual images, through the brain function, by means of neural connections, on local muscle. Visual images are capable of increasing the effectiveness of the result of physical activities performed on any particular body area, through signal processing in the brain and by means of projections from the brain to the spinal cord that are capable of enhancing or inhibiting reflexes. Muscles contraction occurs as a result of conscious effort originating in the brain. After processing the visual image the brain sends signals, in the form of action potentials, through the neural system to the motor neurons that innervate muscle fibers. However, a mere display of an animated human body during the performance of physical activities is not enough to maintain a concentration level of the exerciser that would ensure the achievement of desired results. Establishing a focal point by dynamically highlighting a specific contracting muscle in targeted body area creates visual stimulation to trigger a reflex contraction movement of the same muscle and maintain the exerciser's mental concentration on a specific body area, body part, muscle group or isolated muscle, which the exerciser is usually not able to isolate and concentrate on it on their own.

Visual Signal of Light as Aid of Concentration

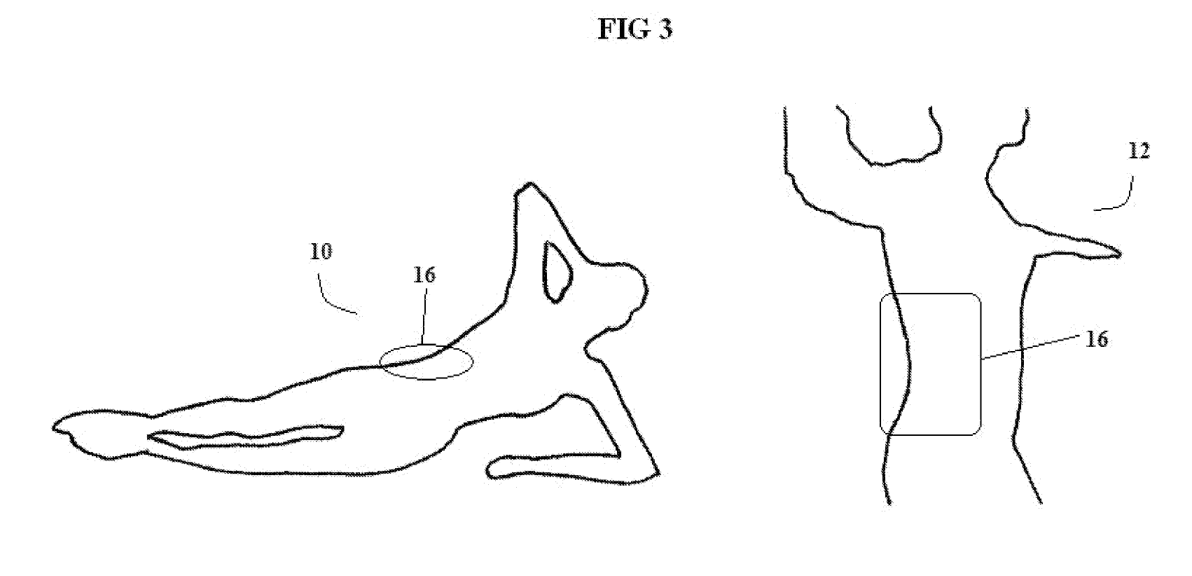

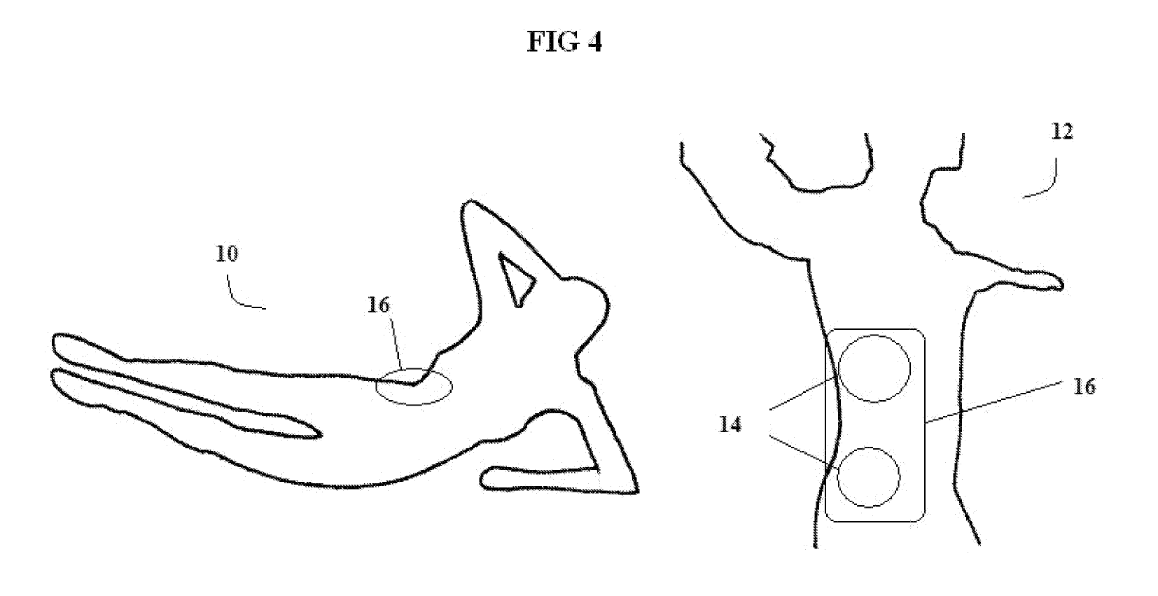

FIGS. 3 and 4 illustrate a display screen where the screen is divided into a plurality of viewable areas that are adjacent to each other, wherein each viewable area displays at least one image of human body areas. A visual image of a human body or muscle carcass may be created by means of computer graphics, 3D graphic or digital software.

FIG. 3 illustrates a depiction of a screen view displayed at a client device at the beginning of the exercise routine. The first viewable area depicts a complete human body FIG. 10 in static or initial position of an exercise that targets a specific body area 16. The second viewable area depicts a body corpus 12, displayed next to body FIG. 10, shows at least one targeted body area 16 In such body position, in this particular embodiment, displayed by FIG. 10, there is no tension in body area 16 and no visual signal of light is employed to overlay any portion of the targeted area of the human body figure. In another embodiment, the visual signal of light may be employed to overlay the portion of the targeted body figure in static, resting or stretching position; however the visual light may be presented in a high or low visual density and/or not flashing when the depiction of the human body is shown to be in a static or initial position of an exercise.

In the embodiment illustrated in FIG. 3, upon selecting by an exerciser, through a client device, an exercise routine of his or her choice, a monitor of a client device will display the first area and the second area wherein the first area depicts a complete human body FIG. 10 and wherein the second area depicts a body corpus 12. The complete human body FIG. 10 and the body corpus 12 are fixed in static or initial position of an exercise that targets a selected body area until the exerciser initiates the exercise routine by switching the mode of the exercise routine from “standby” to “begin.”

In this example, the depiction of the complete human body 10 serves a purpose of illustrating an exercise routine in its optimal form (i.e. position of a body, rate of a body movement, amplitude of the movement, directions of the movement, etc). There is no illumination of the targeted body area by the visual signal of the light on the complete human body 10. The depiction of the body corpus 12 serves the purpose of illuminating of the targeted body area by the visual signal of the flashing light. Referring to FIG. 3, the targeted body area is not highlighted by the visual signal of light while the exercise routine is in “standby” mode.

In another embodiment, referring to FIG. 3, the targeted body area, as shown on the body corpus 12, is highlighted by the visual signal of light of low visual density and not flashing while the exercise routine is in “standby” mode.

In yet another embodiment, referring to FIG. 3, both the complete human body FIG. 10 and the body corpus 12 may have the targeted body area highlighted by the visual light of low visual density where the visual signal of light is not flushing in order to illustrate the fact that the targeted body area is in relaxed, nearly static mode while the exercise routine is in the “standby” mode.

In yet another embodiment, referring to FIG. 3, both the complete human body FIG. 10 and the body corpus 12 may have the targeted body area highlighted by the visual light of low visual density where the visual signal of light is not flashing in order to illustrate the targeted body area while the exercise routine is set to be in the “relaxation”, “meditation” or “yoga” modes.

Upon initiation of an exercise routine, the system may be configured to initiate a stopwatch countdown event to pace the exerciser to assume the position that is suggested by the exercise routine before the system will switch from the “standby” mode to the “active phase” mode of the exercise routine. The stopwatch countdown event may be displayed on the screen, sounded off via optional sound transmitters or both.

In the embodiment, referring to FIG. 3, pertaining to the “relaxation”, “meditation” or “yoga” modes of the exercise routine, the system may be configured to initiate two consequent stopwatch countdown events. The first countdown event is directed at pacing the exerciser to assume the position that is suggested by the exercise routine. The second countdown event is directed at setting up a suggested duration of the selected mode of the exercise routine.

FIG. 4 illustrates a depiction of a screen view displayed at a client device reflecting the exercise routine in progress where at least one viewable area of the screen depicts a complete human body FIG. 10 in dynamic or moving position of an exercise that targets a specific body area 16. While body FIG. 10 displays muscle contraction in target area 16, body corpus 12 displays the visual signal of flashing light 14 that overlays and dynamically illuminates specific muscles in targeted body area 16. The visual signal of flashing light 14 identifies a continuous visual focal point for the exerciser for the entire duration of the exercise routine to ensure triggering of same/correct muscle through concentration and therefore reflex movement of needed muscle. As the exercise routine progresses to the farthest point of the suggested amplitude of the movement, the intensity of the visual signal of flashing light 14 may preferably be greater than the intensity of the visual signal of flashing light 14 highlighting the targeted body area that is in the relaxed and the intermediate positions.

In the preferred embodiment, referring to FIG. 4, upon initiation of an exercise routine, the system may be configured to initiate two consequent stopwatch countdown events. The first stopwatch countdown event is directed at pacing the exerciser to assume the position that is suggested by the exercise routine. The second stopwatch countdown event is initiated immediately after expiration of the first stopwatch countdown event when the system is configured to switch from the “standby” mode to the “active phase” mode of the exercise routine. The said second stopwatch countdown event is directed at setting up and maintaining a suggested duration of the “active phase” mode of the exercise routine.

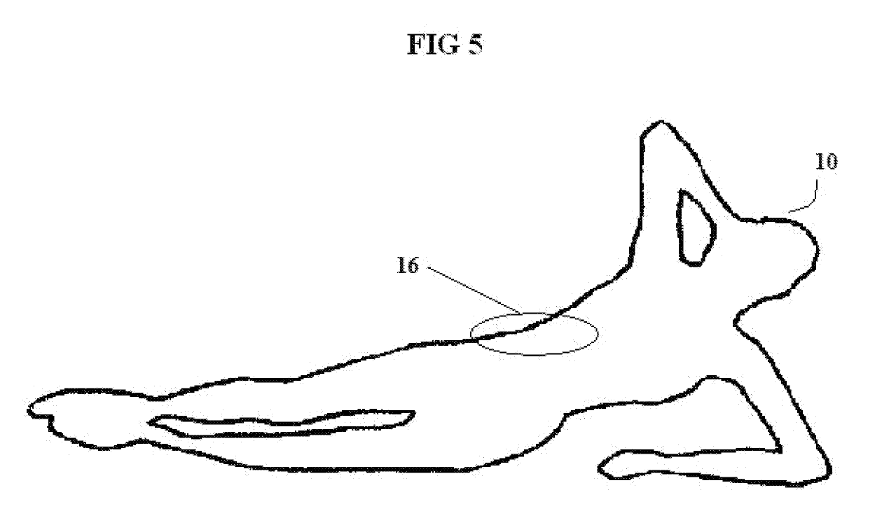

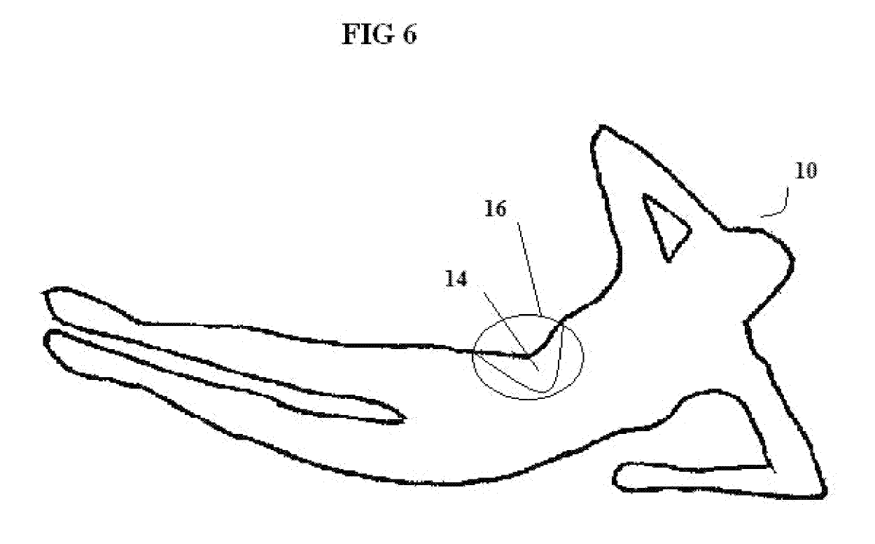

FIGS. 5 and 6 illustrate a depiction of a screen view of a second embodiment of the invention where the singular viewable area of the screen displays a full body FIG. 10 performing an exercise that targets specific body area 16. A visual image of a human body is created by means of computer graphics, 3D graphic or digital software.

FIG. 5 illustrates a singular viewable area of the screen displaying a full body FIG. 10 at the beginning of the exercise routine. The screen displays a complete human body figure in static or initial position of an exercise that targets a specific body area 16. In such body position displayed by FIG. 10, there is no tension in body area 16 and there may be no visual signal of light that overlays any muscles in targeted body area 16 of the human body FIG. 10. In another embodiment, the visual signal of light may be employed to overlay the portion of the targeted body area 16; however the visual light is presented in a low visual density and not flashing when the depiction of the human body is shown to be in static or initial position of an exercise routine.

In yet another embodiment, referring to FIG. 5, the full body FIG. 10 may have the targeted body area highlighted by the visual light of low visual density where the visual signal of light is not flashing in order to illustrate the targeted body area while the exercise routine is set to be in the “relaxation”, “meditation” or “yoga” modes.

In yet another embodiment, pertaining to the “relaxation”, “meditation” or “yoga” modes of the exercise routine, referring to FIG. 5, the system may be configured to initiate two consequent a stopwatch countdown events. The first countdown event is directed at pacing the exerciser to assume the position that is suggested by the exercise routine. The second countdown event is directed at setting up a suggested duration of the selected mode of the exercise routine.

Upon initiation of an exercise routine, the system may be configured to initiate a stopwatch countdown event to pace the exerciser to assume the position that is suggested by the exercise routine before the system will switch from the “standby” mode to the “active phase” mode of the exercise routine. The stopwatch countdown event may be displayed on the screen, sounded off via optional sound transmitters or both.

FIG. 6 illustrates a singular viewable area of the screen displaying the exercise routine in progress where the screen depicts a complete human body FIG. 10 in dynamic or moving position of an exercise that targets a specific body area 16. While body FIG. 10 displays muscle contraction in targeted area 16, the flashing light 14 overlays and dynamically illuminates the muscle in targeted body area 16. The flashing light 14 identifies a point of continuous visual focal point for the duration of the exercise training routine to ensure mental concentration and help trigger particular muscles by means of reflex. Similarly, as exercise routine progresses to the farthest point of the suggested amplitude of the movement, the intensity of the visual signal of flashing light 14 may preferably be greater than the intensity of the visual signal of flashing light 14 highlighting the targeted body area that is in the relaxed and the intermediate positions. Moreover, the intensity of the visual signal may increase progressively from the beginning to the end of the exercise movement. This will further focus the exerciser's attention on completing the exercise in the full range of motion.

In the preferred embodiment, referring to FIG. 6, upon initiation of an exercise routine, the system may be configured to initiate two consequent stopwatch countdown events. The first stopwatch countdown event is directed at pacing the exerciser to assume the position that is suggested by the exercise routine. The second stopwatch countdown event is initiated immediately after expiration of the first stopwatch countdown event when the system is configured to switch from the “standby” mode to the “active phase” mode of the exercise routine. The said second stopwatch countdown event is directed at setting up and maintaining a suggested duration of the “active phase” mode of the exercise routine.

In the preferred embodiment, the system may be configured to provide the exerciser with a vast variety of options to modify personal setting of the system. For example, the exerciser may choose various, throughout a full visual spectrum, colors to be used for illuminating the targeted body area.

In yet another embodiment, the system may be configured to provide the exerciser with the option to choose different colors for different types of exercise routines.

In yet another embodiment, the system may be configured to provide the exerciser with the option to choose different colors for different stages of the selected exercise routines.

The system may be configured to adjust the visual images of the human bodies in the way that when the exerciser chooses the color for the visual signal of light, the system automatically adjusts the depiction of the human body to ensure that the visual signal of light is contrasting and illuminating the targeted body area.

It should be understood that the above description of the preferred embodiments, alternative embodiments, and specific examples, are given by way of illustration and should not be viewed as limiting. Further, many changes and modifications within the scope of the present embodiments may be made without departing from the spirit thereof, and the present invention includes such changes and modifications. For example, the present invention is not limited to the portable systems used by individuals in the comfort of their homes as described hereinbefore, and those skilled in the art will understand that different systems and methods using the visual signal of light as an aid of concentration and an enhancement of body motor reflexes could also be used in various public facilities such as gyms, medical offices, hospitals, etc. It should be understood that the present invention may be applied to or utilized in any video workout programs played in the gym on monitors. As a matter of fact, any kind of workout routines (i.e., created by any party and for any purpose) may be enhanced by the present invention, inside or outside of gym venue.

Further, it will be apparent to those of ordinary skill in the art that methods involved in application of a visual signal of light as aid of concentration and enhancement of body motor reflexes for a wide variety of physical exercises may be embodied in a computer program product that includes one or more computer readable media. For example, a computer readable medium can include a readable memory device, such as a hard drive device, CD-ROM, a DVD-ROM, or a computer diskette, having computer readable program code segments stored thereon. The computer readable medium can also include a communications or transmission medium, such as, a bus or a communication link, either optical, wired or wireless having program code segments carried thereon as digital or analog data signals.

The claims should not be read as limited to the described order or elements unless stated to that effect. Therefore, all embodiments that come within the scope and spirit of the following claims and equivalents thereto are claimed as the invention.

What is claimed is:

1. A method of application of a visual signal of light as aid of concentration and enhancement of body motor reflexes, comprising:
receiving, by a processor, at least one set of instructions from a client device, wherein the at least set of instructions comprises at least system parameter and at least one exercise routine parameter;
identifying, by the processor, at least one exercise routine in response to receiving the at least one set of instructions from the client device, wherein the at least one exercise routine targets at least one body area;
enhancing, by the processor, the at least one exercise routine by the at least one system parameter received from the client device;
communicating, by the processor, the at least one exercise routine to the client device;
displaying, by the processor, a first image,
wherein the first image depicts at least one targeted body area,
wherein the at least one targeted body area is illuminated by the visual signal of light,
wherein the first image is in static mode, and
wherein the visual signal of light illuminates the at least one targeted body area with constant light intensity;
initiating, by the processor, a countdown of time allocated for the first image to be displayed on a screen of the client device;
upon lapse of the time allocated for the first image to be displayed on the screen of the client device, displaying, by the processor, a second image,
wherein the second image depicts at least one targeted body area,
wherein the at least one targeted body area is illuminated by the visual signal of light,
wherein the second image is in dynamic mode, and
wherein the visual signal of light illuminates the at least one targeted body area with fluctuating light intensity;
initiating, by the processor, a countdown of time allocated for the second image to be displayed on the screen of the client device.

2. The method of claim 1,
wherein the at least one system parameter directs the processor to display at least one image on the screen of the client device, and
wherein the at least one exercise routine parameter directs the processor to identify the at least one exercise routine.

3. The method of claim 1, wherein enhancing the at least one exercise routine to illuminate the at least one targeted body area with a visual signal of light comprises positioning, by the processor, of the visual signal of light to overlay the at least one targeted body area establishing a focal point as an aid to intensify a brain signal processing to enhance reflexes in the at least one targeted body area, the visual signal of light exerting an influence applied to the at least one targeted body area, whereby effectuating an enhancement of the at least one targeted body area.

4. The method of claim 1, wherein the targeted body area consists of at least one of a muscle, tissue, ligament, joint, organ, bone and blood vessel.

5. The method of claim 3, wherein the visual signal of light comprises the wavelength of the light that is different from the wavelength of the light of the targeted body area.

6. The method of claim 1, wherein the light intensity of the visual signal of light fluctuates in correlation with the exercise routine depicted on the second image.

7. The method of claim 1, wherein the first and the second images also comprise a non-targeted body area that is not illuminated by the visual signal of light.

8. The method of claim 1, wherein the second image comprises the targeted body area in the static mode.

9. The method of claim 1, wherein in the beginning of the exercise routine the wavelength of the visual signal of light differs from the wavelength of the light at the end of the exercise routine.

10. The method of claim 1, wherein the fluctuation of the light intensity of the visual signal of light depends from the exercise routine depicted on the second image.

11. The method of claim 1, wherein fluctuating light intensity in the second image comprises:
illuminating the targeted body area with the visual signal of light of a first light intensity during the first portion of the exercise routine and during the last portion of the exercise routine; and
illuminating the targeted body area with the visual signal of light of a second light intensity during at least one intermediate portion of the exercise routine.

12. The method of claim 11, wherein visual signal of light varies progressively between the first and the second light intensities.

13. The method of claim 11, wherein the second intensity is greater than the first intensity.

14. The method of claim 10, wherein the exercise routine consists of at least one of:
tension;
relaxation;
static state;
dynamic state;
rehabilitation;
attention focus;
concentration;
preparation; and
selection modes.

15. An apparatus for application of a visual signal of light as aid of concentration and enhancement of body motor reflexes, comprising:
a memory operable to store at least one set of instructions from a client device; and
a processor communicatively coupled to the memory and operable to:
receive at least one set of instructions from a client device, wherein the at least set of instructions comprises at least one system parameter and at least one exercise routine parameter;
identify at least one exercise routine in response to receiving the at least one set of instructions from the client device, wherein the at least one exercise routine targets at least one body area;
enhance the at least one exercise routine by the at least one system parameter received from the client device;
communicate the at least one exercise routine to the client device;
display a first image,
wherein the first image depicts at least one targeted body area,
wherein the at least one targeted body area is illuminated by the visual signal of light,
wherein the first image is in static mode, and
wherein the visual signal of light illuminates the at least one targeted body area with constant light intensity;
initiate a countdown of time allocated for the first image to be displayed on a screen of the client device;
upon lapse of the time allocated for the first image to be displayed on the screen of the client device, display a second image,
wherein the second image depicts at least one targeted body area,
wherein the at least one targeted body area is illuminated by the visual signal of light,
wherein the second image consists of at least one of a dynamic mode and static mode; and
wherein the visual signal of light illuminates the at least one targeted body area with fluctuating light intensity;
initiate a countdown of time allocated for the second image to be displayed on the screen of the client device.

16. The apparatus of claim 15, wherein enhancing the at least one exercise routine to illuminate the at least one targeted body area with a visual signal of light comprises positioning, by the processor, of the visual signal of light to overlay the at least one targeted body area establishing a focal point as an aid to intensify a brain signal processing to enhance reflexes in the at least one targeted body area.

17. The apparatus of claim 15, wherein the visual signal of light comprises the wavelength of the light that is different from the wavelength of the light of the targeted body area.

18. The apparatus of claim 15, wherein fluctuating light intensity in the second image comprises:
illuminating the targeted body area with the visual signal of light of a first light intensity during the first portion of the exercise routine and during the last portion of the exercise routine; and
illuminating the targeted body area with the visual signal of light of a second light intensity during at least one intermediate portion of the exercise routine.

19. The apparatus of claim 18, wherein visual signal of light varies progressively between the first and the second light intensities; wherein the second intensity is greater than the first intensity; and wherein fluctuating light intensity comprises displaying the targeted body area in an intermediate point in the exercise with the visual signal of light in a third light intensity.

20. The apparatus of claim 15, wherein the fluctuation of the light intensity of the visual signal of light depends from the exercise routine.
